(19) United States
(12) Patent Application Publication
(10) Pub. No.: US 2020/0180406 A1
(43) Pub. Date: Jun. 11, 2020

(54) SHADE ASSEMBLY USED IN VEHICLES

(71) Applicant: AL-KOR MAKINA KALIP SANAYI VE TICARET A.S., ISTANBUL (TR)

(72) Inventor: Erol DIVANYAN, Istanbul (TR)

(73) Assignee: AL-KOR MAKINA KALIP SANAYI VE TICARET A.S., ISTANBUL (TR)

(21) Appl. No.: 16/614,808

(22) PCT Filed: May 15, 2018
(86) PCT No.: PCT/TR2018/000044

§ 371 Date: Nov. 19, 2019

(30) Foreign Application Priority Data
May 29, 2017 (TR) 2017/07855

(51) Int. Cl. B60J 1/20

(52) U.S. Cl. CPC B60J 1/2058; B60J 1/2063; B60J 1/2052; B60J 1/205

(57) ABSTRACT

A shade assembly includes a tube, a rod disposed linearly within the tube, a first mounting member through which the rod is passed, a first spring wound onto the rod, and opposing caps at which the ends of the tube are located. The shade assembly includes a first protrusion which is fixed to the second cap from one end of the rod such that it prevents a rotational movement, a first grooved portion configured to mount one side of the first spring to the first mounting member, and a hook portion configured to be connected to other end of the rod from another side of the first spring.

### CROSS REFERENCE TO THE RELATED APPLICATIONS

This application is the national phase of International Application No. PCT/TR2018/000044, filed on May 15, 2018, which is based upon and claims priority to Turkish Patent Application No. TR2017/07855, filed on May 29, 2017, the entire contents of which are incorporated herein by reference.

### TECHNICAL FIELD

The invention relates to a shade assembly which is used in vehicles and allows the shade to be retracted when it is released.

### BACKGROUND

In the state of the art, shade assemblies are known, which are used in vehicles and allow the shade to be retracted. In such shade assemblies, the number of parts in the mechanisms for retracting the shade is rather high, and hence its assembly is difficult and the cost of manufacture is high. Further, the costs are much higher in these mechanisms, in the case that the rotational movement required for retracting the shade is provided by drive members. Therefore, there is a need for solutions which have lesser parts, is easy to assembly and have reduced cost of manufacture such that the shade is enabled to retract in the vehicles.

Patent Application US 2016/0083998 discloses a roller shade assembly a cylindrical tube having an inner surface defining an axial bore; a spindle including an outer threaded portion defining a helical groove, the spindle being configured to be received in the axial bore of the cylindrical tube for axial movement in the cylindrical tube at one end of the cylindrical tube; and at least one tracking element operatively associated with the cylindrical tube, the at least one tracking element being configured for riding in the helical groove to convert axial rotation of cylindrical tube into axial movement of the cylindrical tube on the support tube. The tracking element engages the helical groove from a position proximal to one end of the cylindrical tube. The starting axial position of the cylindrical tube in relation to the support tube is configured to be adjustable by manually rotating the spindle without rotating the support tube.

### SUMMARY

The object of the invention is to provide a shade assembly which allows the shade to be retracted, has less number of parts and is easy to assembly.

Another object of the invention is to provide a shade assembly having a reduced cost of manufacture.

To achieve said object, the invention provides a shade assembly comprising a tube for winding a shade used in vehicles, a rod disposed linearly within the tube, a first mounting member through which said rod is passed, a first spring wound onto the rod, and opposing caps at which the ends of the tube are located. The shade assembly of the invention comprises a first protrusion which is fixed to the second cap from one end of the rod such that it prevents a rotational movement, a first grooved portion configured to mount one side of the first spring to the first mounting member, and a hook portion configured to be connected to other end of the rod from another side of the first spring. Thus, energy is accumulated in the first spring by the rotational movement of the tube. The energy accumulated in the first spring is used to retract the shade. In this way, an inexpensive solution with fewer parts is provided for retracting the shade.

In a possible embodiment of the invention, there is provided on the rod a second protrusion for attaching the first hook portion and a head configured to engage said second protrusion. Thus, a protrusion and head is provided for the spring to accumulate energy.

In a possible embodiment of the invention, the first mounting member comprises a first mounting member recess in which the tube is disposed and a tab engaging a hole on the tube on its side facing the tube. Thus, the first mounting member is fixed onto the tube.

In a possible embodiment of the invention, there is provided a longitudinal aperture on the tube. Thus, the tube is prevented from disengaging from the guiding member during rotation.

In a possible embodiment of the invention, there is provided a guiding member having a guiding member channel configured to receive one end of the tube. Thus, the tube is prevented from disengaging from the guiding member during rotation.

In a possible embodiment of the invention, the first cap has a first cap groove to which one end of the guiding member is attached, by allowing the rotational movement. Thus, a member to which the guiding member is attached during rotational movement is provided.

In a possible embodiment of the invention, the second cap comprises a second cap groove for receiving the first protrusion.

In a possible embodiment of the invention, there is provided an extension configured to be away from one surface of the guiding member facing the first cap, and a threaded portion having at least one thread on said surface.

In a possible embodiment of the invention, there is provided a fourth cap channel which extends along the first cap and through which the extension is passed, and a corresponding threaded portion having at least one thread corresponding to the threaded portion on the first cap groove.

In a possible embodiment of the invention, there is provided a housing having a housing channel for receiving the tube. Thus, a housing which surrounds and protects the assembly is provided.

In a possible embodiment of the invention, the first cap and second cap have at least one connecting hole, there is provided at least one housing hole corresponding to the connecting hole on the housing, and there is provided at least one connecting member for fastening said caps to the housing. Thus, the assembly is fixed onto the protective housing.

In a possible embodiment of the invention, there is provided a housing aperture on the housing, which allows the shade to pass through. Thus, an aperture is provided for the shade during extending and retracting processes.

In order to achieve said object, the invention provides a shade assembly comprising a tube for winding a shade used in vehicles and a second spring disposed linearly within the tube. The shade assembly of the invention comprises a third cap with an extension which extends into the tube and located at the opposing ends of the tube, a spring fixing member located fixedly within the tube for fastening the second spring, and a second hook portion of the second spring configured to be attached to the spring fixing member from one end thereof and to the third cap from another end thereof. Thus, energy is accumulated in the second spring by the rotational movement of the tube. The energy accumulated in the second spring is used to retract the shade. Thus, an inexpensive solution with fewer parts is provided for retracting the shade.

In a possible embodiment of the invention, the extension of the third cap has a slot for receiving the second hook portion. Thus, a slot for attaching the spring is provided.

In a possible embodiment of the invention, the extension of the third cap comprises at least one tube guiding member through which the tube guiding member channel is passed. Thus, a guiding member for guiding the tube is provided for the rotational movement.

In a possible embodiment of the invention, the tube has an aperture extending longitudinally thereon. Thus, the tube is prevented from disengaging from the guiding member during rotation.

In a possible embodiment of the invention, the tube guiding member has a second grooved portion for attaching to an inner wall of the tube, and a protrusion for locating in the aperture. Thus, the tube guiding member is fixed to the inner walls of the wall.

In a possible embodiment of the invention, there is provided a housing having a housing passage for accommodating the tube. Thus, a housing which surrounds and protects the assembly is provided.

In a possible embodiment of the invention, the third cap has at least one connecting hole, and wherein at least one housing hole corresponding to the connecting hole is present on the housing, and wherein there is at least one connecting member for fixing the third cap to the housing. Thus, the assembly is fixed on the protective housing.

In a possible embodiment of the invention, the housing has a housing aperture allowing the shade to pass therethrough. Thus, an aperture is provided for the shade during extending and retracting processes.

### BRIEF DESCRIPTION OF THE DRAWINGS

FIG. 1 shows an exploded view showing the first assembly.

FIG. 2 shows a representative view of a first cap in the first assembly.

FIG. 3 shows a sectional view of a first cap in the first assembly.

FIG. 4 shows a representative view of a guiding member in the first and second assembly.

FIG. 5 shows a sectional view of a guiding member in the first and second assembly.

FIG. 6 shows a representative view of a head in the first and second assembly.

FIG. 7 shows a top view of a head in the first and second assembly.

FIG. 8 shows a sectional view of a head in the first and second assembly.

FIG. 9 shows a top view of a spring in the first and second assembly.

FIG. 10 shows a front view of a spring in the first and second assembly.

FIG. 11 shows a representative view of a mounting member in the first and second assembly.

FIG. 12 shows a sectional view of a mounting member in the first and second assembly.

FIG. 13 shows a representative view of a second cap in the first and second assembly.

FIG. 14 shows a sectional view of a second cap in the first and second assembly.

FIG. 15 shows an exploded view showing the third assembly.

FIG. 16 shows a sectional view showing the third assembly.

FIG. 17 shows a front view of a second spring in the third assembly.

FIG. 18 shows a front view of a spring fixing member in the third assembly.

FIG. 19 shows a representative view of a spring fixing member in the third assembly.

FIG. 20 shows a representative view of a tube guiding member in the third assembly.

FIG. 21 shows a sectional view of a tube guiding member in the third assembly.

FIG. 22 shows a representative view of a third cap in the third assembly.

FIG. 23 shows a sectional view of a third cap in the third assembly.

FIG. 24 shows an exploded view showing the second assembly.

FIG. 25 shows a sectional view showing the second assembly.

FIG. 26 shows a representative view of a fourth cap in the second assembly.

FIG. 27 shows a sectional view of a fourth cap in the second assembly.

FIG. 28 shows a representative view of a second mounting member in the second assembly.

FIG. 29 shows another representative view of a second mounting member in the second assembly.

FIG. 30 shows a sectional view of a second mounting member in the second assembly.

FIG. 31 shows a representative view of a housing in the first, second and third assembly.

FIG. 32 shows a representative view of a tube in the first, second and third assembly.

FIG. 33 shows a front view of a tube in the first, second and third assembly.

FIG. 34 shows a front view showing a rod in the first and second assembly.

FIG. 35 shows a sectional view showing a rod in the first and second assembly.

### REFERENCE NUMERALS

1. First assembly
2. Second assembly
3. Third assembly
4. First cap
41. First cap recess
42. First cap groove
43. First cap flange
44. First connecting hole
5. Second cap
51. Second cap recess
52. Second cap groove
53. Second cap flange
54. Second connecting hole
6. Housing
61. Housing channel
62. Housing hole
63. Housing aperture
7. Tube
71. Aperture
8. First spring
81. First helical portion
82. First hook portion
9. Rod
91. First protrusion
92. Second protrusion
10. Guiding member
101. First body
102. Second body
103. Front surface
104. Guiding member channel
105. Guiding member hole
11. Head
111. Groove
112. Conical surface
12. First mounting member
121. First mounting member body
122. Spindle
123. First grooved portion
124. First mounting member recess
125. Tab
126. First mounting member channel
13. Second spring
131. Second helical portion
132. Second hook portion
14. Second mounting member
141. Second mounting member body
142. First surface
143. Second surface
144. Extension
145. Second mounting member channel
146. Hole
147. Threaded portion
15. Tube guiding member
151. Tube guiding member channel
152. Second grooved portion
153. Lateral surface
154. Protrusion
155. Tube guiding member extension
156. First circular ridge
157. Second circular ridge
16. Spring fixing member
161. First slot
162. Upper surface
163. Side surface
164. Second spindle
17. Third cap
171. Third cap recess
172. Third cap flange
173. Third connecting hole
174. Third cap extension
175. Second slot
176. Circular wall
18. Fourth cap
181. Fourth cap recess
182. Fourth cap channel
183. Ridge
184. Corresponding threaded portion
185. Fourth cap flange
186. Fourth connecting hole
19. Connecting member

### DETAILED DESCRIPTION OF THE EMBODIMENTS

In this detailed description, three different shade assemblies used in vehicles are described by way of examples only for better understanding the subject matter without limitation.

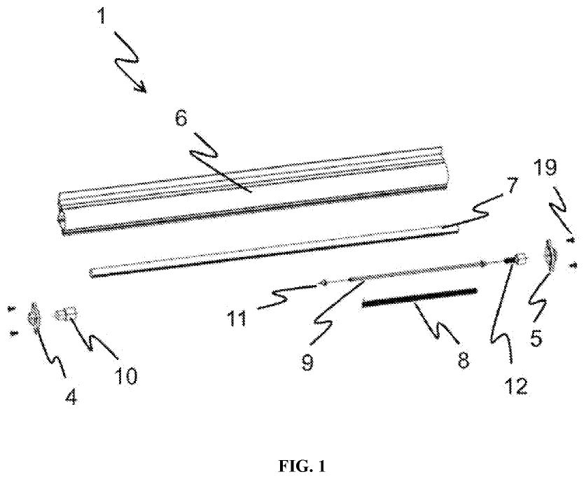

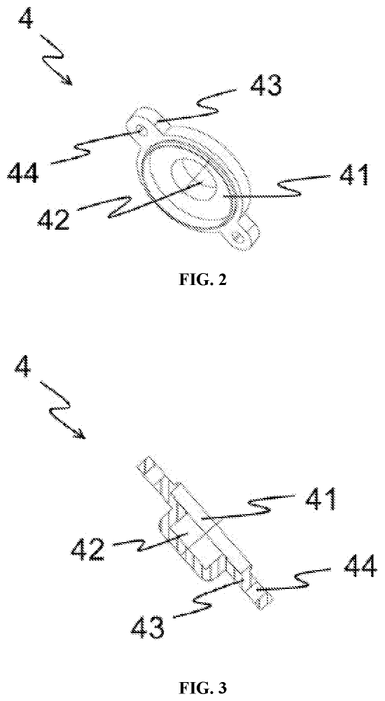

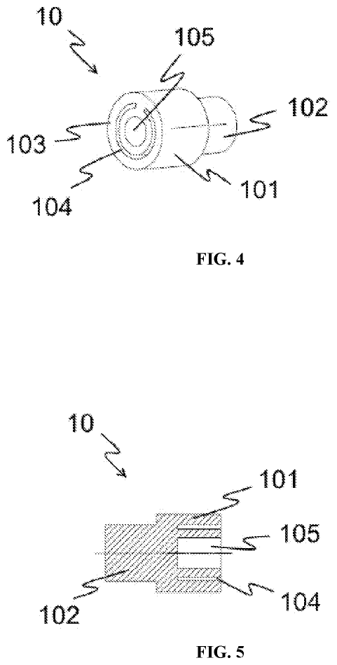

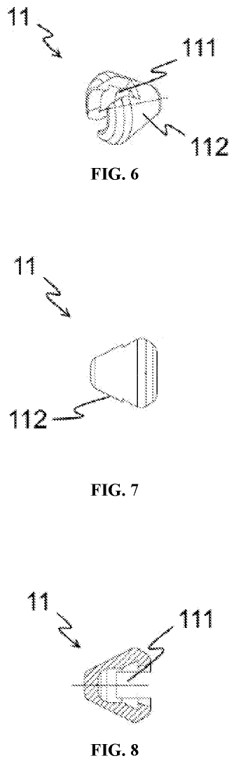

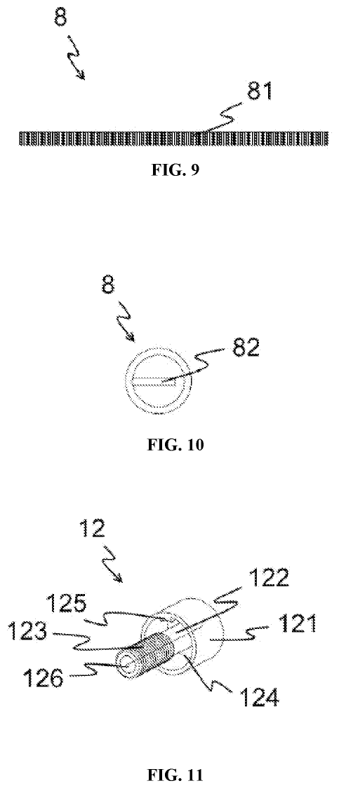

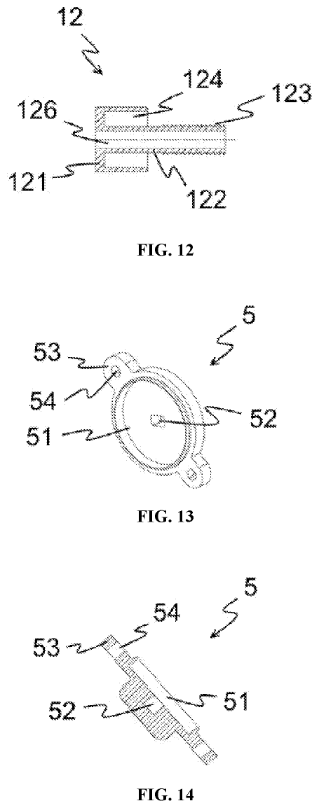

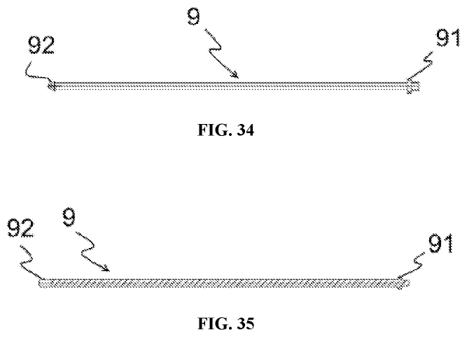

FIG.1 is an exploded view of a first assembly (1). The first assembly (1) generally has a tube (7) for winding a shade used in vehicles, a rod (9) disposed linearly within the tube (7), a first mounting member (12) through which said rod (9) is passed, a first spring (8) wound onto the rod (9), and opposing caps (4, 5) at which the ends of the tube (7) are located. A first cap (4) shown in the FIG. 2 and FIG. 3 has a geometrically cylindrical shape. A first cap recess (41) is present on the first cap (4). Said first cap recess (41) has a second cap groove (52). In a preferred embodiment, said first cap recess (41) and the second cap groove (52) is provided in the form of a circle. The first cap (4) has at least one cap flange (43) thereon, which is configured to be away from the cap. At least one connecting hole (44) is present on the first cap flange (43). FIG. 4 and FIG. 5 is representative and sectional views of a guiding member (10) in the first and second shade assembly. The guiding member (10) is generally cylindrical. The guiding member (10) is formed by a first body (101) and a second body (102), which have cylindrical shapes. In a more detailed embodiment, the guiding member (10) is formed by end-to-end joining the first body (101) and the second body (102), which have different diameters. A guiding member channel (104) is present on the front surface (103) of the first body (101) in the guiding member (10). In a preferred embodiment, said guiding member channel (104) has a “C” shape. Also, the first body (101) of the guiding member (104) has a guiding member hole (105). FIG. 6, FIG. 7 and FIG. 8 shows a head (11) comprised in the first and second assembly (2). Said head (11) has a generally conical surface (102). A groove (111) is located at the middle of the head (11). FIG. 9 and FIG. 10 show a first spring (8) in the first and second assembly (1, 2). The first spring (8) has a first helical portion (81) of a circular shape and a first hook portion (82) at both ends of the first helical portion (81). FIG. 11 and FIG. 12 are views of a first mounting member (12) in the first and second assembly (1, 2). The first mounting member (12) comprises a first cylindrical mounting member body (121), a first mounting member recess (124) provided within said first mounting member body (121), and a spindle (122) extending horizontally away from the first mounting member (12) through the first mounting member recess (124). A first mounting member channel (126) extends through said spindle (122). A first grooved portion (123) is provided at one end of the spindle (122). A tab (125) is provided on an inner wall of the first mounting member body (121) facing the first mounting member recess (124). Said tab (125) is defined as an extension extending from the inner wall of the first mounting member body (121) to the spindle (122). FIG. 13 and FIG. 14 are views of a second cap (5) in the first and second assembly (1, 2). The second cap (5) is cylindrical in shape. A second cap recess (51) is provided on the second cap (5). In a preferred embodiment, said second cap recess (51) is circular in shape. Said second cap recess (51) has a second cap groove (52). At least one second cap flange (53) configured to be away from the cap is provided on the second cap (5). At least one second connecting hole (54) is provided on the second cap flange (53). FIG. 34 and FIG. 35 are views of a circular linear rod (9) in the first assembly (1) and the second assembly (2). A first protrusion (91) is provided proximal to one end of the rod (9). A second protrusion (92) is provided at the other end of the rod (9). In a preferred embodiment, said second protrusion (92) is conical in shape.

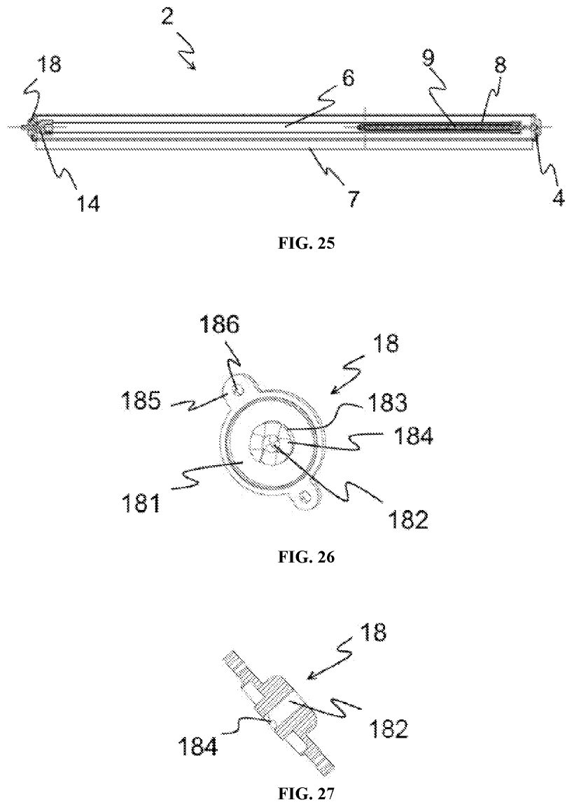

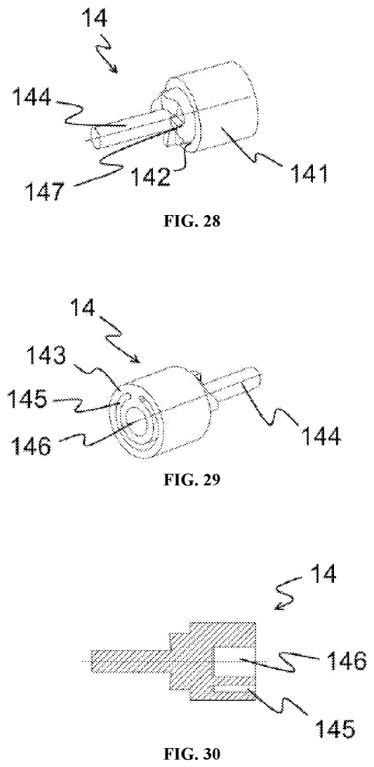

FIG. 24 is an exploded view of the second assembly (2) and FIG. 25 is a sectional view of the second assembly (2). The second assembly (2) comprises generally a tube (7) for winding a shade, a rod (9) disposed linearly within the tube (7), a first mounting member (12) through which said rod (9) is passed, a first spring (8) wound onto the rod (9), and opposing first cap (4) and fourth cap (18) at which the ends of the tube (7) are located. FIG. 26 and FIG. 27 are views of the fourth cap (18). The fourth cap (18) is cylindrical in shape. A fourth cap recess (181) is provided on the fourth cap (18). In a preferred embodiment, said fourth cap recess (181) is circular in shape. A circular ridge (183) is provided in said fourth cap recess (181). There is provided a fourth cap channel (182) extending along the fourth cap (18) from the ridge (183). In addition, a corresponding threaded portion (184) is provided on said ridge (183) on which a corresponding thread is present. At least one fourth cap flange (185) configured to be away from the cap is provided on the fourth cap (18). At least one fourth connecting hole (186) is provided on the fourth cap flange (185). FIG. 28, FIG. 29 and FIG. 30 are views of the second mounting member (14) in the second assembly (2). The second mounting member (14) comprises a second cylindrical mounting member body (141) and a threaded portion (147) with at least one thread provided on a first surface (142) of said second mounting member body (141). Said threaded portion (147) is configured to correspond to the threaded portion (184) on the fourth cap (18). In a more detailed embodiment, the threaded portion (147) and the corresponding threaded portion (184) are complementary to each other. On the other hand, there is provided an extension (144) extending horizontally away from the second mounting member (14) on the first surface (142). There is provided a second mounting member channel (145) on a second surface (143) corresponding to the first surface (142). In a preferred embodiment, said second mounting member channel (145) has a “C” shape. There is provided a hole (146) which is located on the second surface (143) of the second mounting member (14) and is extended along at least part of the second mounting member body (141).

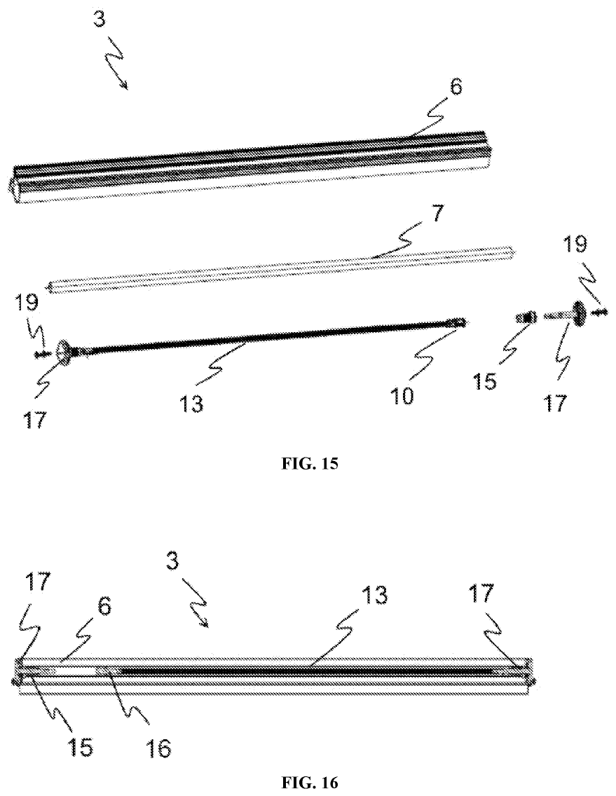

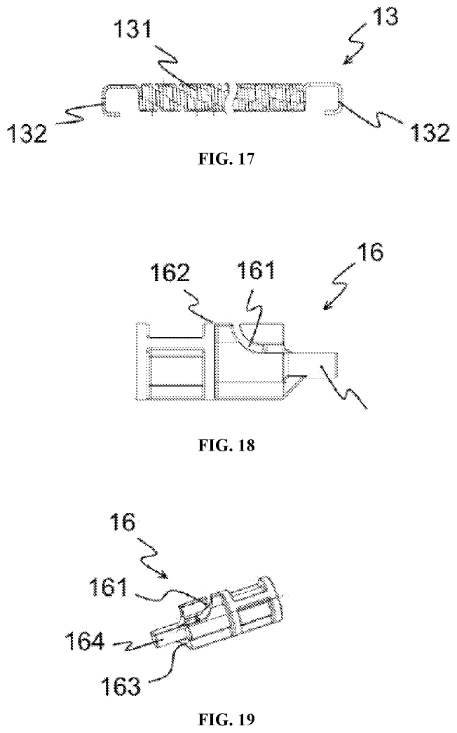

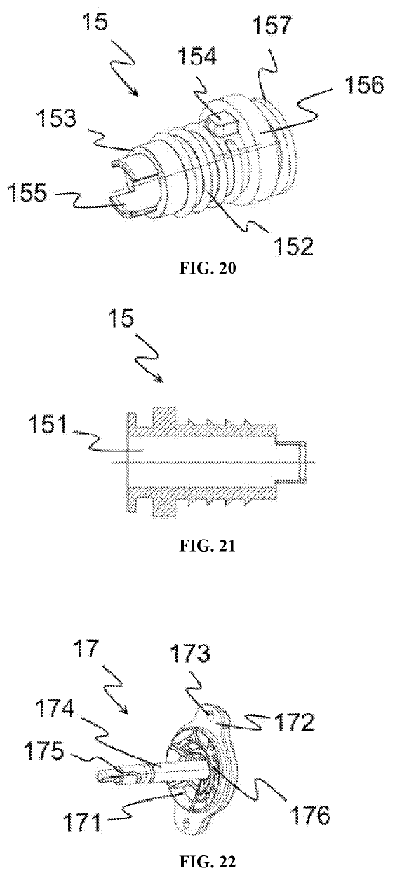

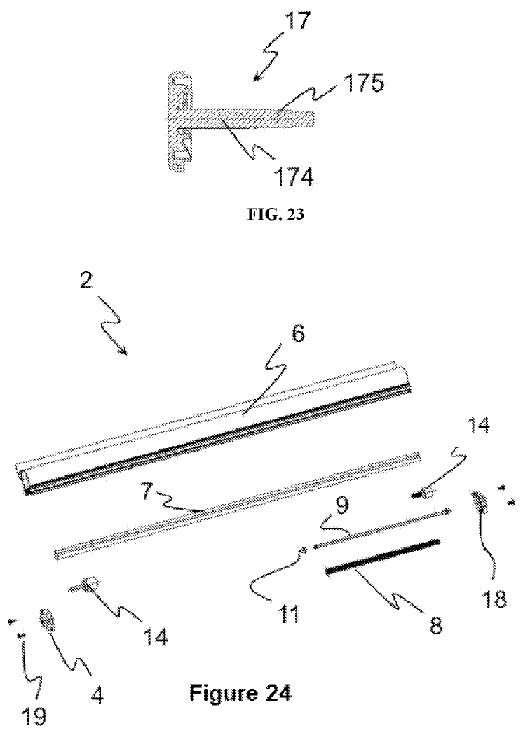

FIG. 15 and FIG. 16 are exploded and sectional views of a third assembly (3). The third assembly (3) comprises generally a tube (7) for winding a shade used in vehicles, a second spring (13) disposed linearly within the tube (7), a third cap (17) having an extension located at the opposing ends of the tube (7) and extending through the tube (7) and a spring fixing member (16) located fixedly within the tube (7) for fastening the second spring (13). The second spring (13) in the third assembly (3) shown in FIG. 17 has a second circular helical portion (131) and at least one second hook portion (132) at both ends of the second helical portion (131). In a preferred embodiment, said second hook portion (132) has a “C” shape. FIG. 18 and FIG. 19 are views of the spring fixing member (16). The spring fixing member (16) has a rectangular shape and has a first slot (161) thereon. In a preferred embodiment, said first slot (161) is inclined downwardly from an upper surface (162) of the spring fixing member (16). There is provided a second spindle (164) extending horizontally from a side surface (163) of the spring fixing member (16). FIG. 20 and FIG. 21 are views of a tube guiding member (15) in the third assembly (3). Said tube guiding member (15) has a circular shape. The tube guiding member (15) has a tube guiding member channel (151) therethrough and a second grooved portion (152) on a lateral surface (153) thereof. Also, said lateral surface (153) has a protrusion (154). The tube guiding member (15) has a tube guiding member extension (155) on one end thereof, and a first circular ridge (156) and a second circular ridge (157) on the other end thereof, in an opposite direction. FIG. 22 and FIG. 23 are views of a third cap (17) in the third assembly (3). The third cap (17) has generally a cylindrical shape. There is provided a third cap recess (171) on the third cap (17).

In a preferred embodiment, said third cap recess (171) is circular in shape. At least one third cap flange (172) configured to be away from the cap is provided on the third cap (17). At least one third connecting hole (173) is provided on the third cap flange (172). There is provided a third cap extension (174) configured to be away from the third cap recess (171) and a circular wall (176) in said third cap recess (171). In a preferred embodiment, said wall is provided in a “C” shape. Further, a second slot (175) is provided on the third cap extension (174).

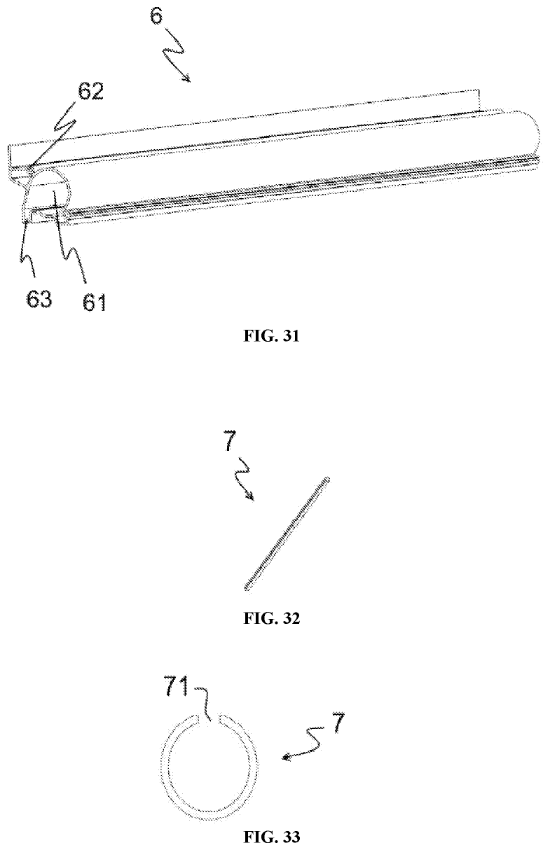

FIG. 31 shows a housing (6) used in the first assembly (1), second assembly (2) ant third assembly (3). Said housing (6) has a housing channel (61) thereon in which the tube (7) is accommodated. In a preferred embodiment, said housing channel (61) is a hollow cylinder. Said housing channel (61) has a housing aperture (63) which communicates with outside and allows the shade to pass through.

FIG. 32 shows views of the cylindrical tube (7) used in the first assembly (1), second assembly (2) ant third assembly (3). Said cylindrical tube (7) has a longitudinal aperture (71) thereon. In a more detailed embodiment, the tube (7) is in the form of “C” shape.

Assembly and operation of the first assembly (1) is as follows: The first spring (8) is wound onto the rod, and the first spring (8) is attached to the second protrusion (92) of the rod (9) from one side thereof and is fixed to the head (11). The first spring (8) is attached to the first grooved portion (123) from the other side thereof. The first protrusion (91) of the rod (9) is passed through the guiding member hole (126). The rod (9) is disposed within the tube (7) along with the first spring (8) thereon. The rod (9) is placed in the second cap groove (52) of the second cap (5) from one side thereof such that it will not rotate and is positioned in the guiding member (10) from the other side thereof. The guiding member (10) is positioned in the first cap groove (42) of the first cap (4). One end of the tube (7) is located within the guiding member channel (104). The system thus mounted is placed in the housing channel (61) and fixed by at least one connecting member (19) through the connecting holes (44, 54) on the first cap (4) and second cap (5), and the housing hole (62). In the first assembly (1) thus mounted, energy is accumulated in the first spring (8) by the rotational movement of the tube (7). The energy accumulated in the first spring (8) is used to retract the shade by rotating the tube (7) in the opposite direction.

Assembly and operation of the second assembly (2) is as follows: The first spring (8) is wound onto the rod (9), and the first spring (8) is attached to the second protrusion (92) of the rod (9) from one side thereof and is fixed to the head (11). The rod (9) is inserted into the hole (146) from the other side thereof, whereas one end of the tube (7) is positioned in the second mounting member channel (145). The extension (144) is passed through the fourth cap channel (182). In such case, threads of the corresponding threaded portion (184) and the threaded portion (147) are complementarily integrated. The rod (9) is disposed within the tube (7) along with the first spring (8) thereon. The rod (9) is passed through the fourth cap (18) from one side thereof such that it will not rotate and is positioned in the guiding member (10) from the other side thereof. The guiding member (10) is positioned in the first cap groove (42) of the first cap (4). The system thus mounted is placed in the housing channel (61) and fixed by at least one connecting member (19) through the connecting holes (44, 54) on the first cap (4) and fourth cap (18), and the housing hole (62). The corresponding threaded portion (184) and the threaded portion (147) are disengaged by a force applied linearly to the extension (144). In the first assembly (1) thus mounted, energy is accumulated in the first spring (8) by the rotational movement of the tube (7). The energy accumulated in the first spring (8) is used to retract the shade by rotating the tube (7) in the opposite direction.

Assembly and operation of the third assembly (3) is as follows: The second spring is positioned between the spring fixing member (16) and the third cap (17) on the tube. The second spring (13) is fixed by being attached to the first slot (161) on the spring fixing member (16) from one end thereof and to the second slot (171) on the third cap (17) from the other end thereof. The tube guiding member (15) is provided at both ends of the tube (7) and the third cap extension (174) of the third cap (17) is passed through the tube guiding member channel (151). The protrusion (154) is located at the aperture of the tube. The tube (7) is located at the second slot (171) by the circular wall (176) from both ends thereof. The system thus mounted is placed in the housing channel (61) and fixed by at least one connecting member (19) through the third cap connecting holes (173) on the third caps (13), and the housing hole (62). In the first assembly (1) thus mounted, energy is accumulated in the second spring (13) by the rotational movement of the tube (7). The energy accumulated in the second spring (13) is used to retract the shade by rotating the tube (7) in the opposite direction.

What is claimed is:

1. A shade assembly comprising:
a tube for winding a shade used in vehicles,
a rod disposed linearly within the tube,
a first mounting member, wherein the rod is passed through the first mounting member,
a first spring wound onto the rod,
a first cap and a second cap, wherein ends of the tube are located on the first cap and the second cap,
a first protrusion fixed to the second cap from one end of the rod to prevent a rotational movement,
a first grooved portion configured to mount one side of the first spring to the first mounting member,
and a first hook portion configured to be connected to an other end of the rod from another side of the first spring.

2. The shade assembly according to claim 1, further comprising a second protrusion configured to receive the first hook portion and a head configured to be placed into the second protrusion are provided on the rod.

3. The shade assembly according to claim 1, wherein, the first mounting member comprises a first mounting member recess, the tube is disposed in the first mounting member recess; and a tab engaging a hole on the tube on a side of the tab facing the tube.

4. The shade assembly according to claim 3, further comprising: an aperture extending longitudinally on the tube.

5. The shade assembly according to claim 4, further comprising a guiding member having a guiding member channel configured to receive one end of the tube.

6. The shade assembly according to claim 5, wherein, the first cap has a first cap groove, which one end of the guiding member is located on the first cap grove to allow a rotational movement.

7. The shade assembly according to claim 1, wherein, the second cap comprises a second cap groove configured to receive the first protrusion.

8. The shade assembly according to claim 5, further comprising is an extension configured to be away from one surface of the guiding member facing the first cap and a threaded portion having at least one thread on the one surface.

9. The shade assembly according to claim 8, further comprising a fourth cap channel extending along the first cap and the extension is passed through the fourth cap channel, and a corresponding threaded portion with at least one thread corresponding to the threaded portion on the first cap groove.

10. The shade assembly according to claim 9, further comprising a housing with a housing channel for accommodating the tube.

11. The shade assembly according to claim 10, wherein, the first cap and the second cap have at least one connecting hole, and wherein at least one housing hole corresponding to the connecting hole is provided on the housing, and wherein at least one connecting member is provided for fixing the first cap and the second cap to the housing.

12. The shade assembly according to claim 10, wherein, the housing has a housing aperture allowing the shade to pass therethrough.

13. A shade assembly comprising:
a tube for winding a shade used in vehicles;
a first spring disposed linearly within a tube;
a first cap with an extension is located at opposite ends of the tube and extended along the tube,
a spring fixing member is located within the tube in a fixed manner for fastening the first spring,
and a first hook portion of the first spring is configured to be attached to the spring fixing member from one end thereof and to the first cap from another end thereof.

14. The shade assembly according to claim 13, wherein, the extension of the third cap has a slot for receiving the first hook portion.

15. The shade assembly according to claim 13, wherein, the extension of the first cap comprises at least one tube guiding member; a channel for the extension of the first cap is passed through the at least one tube guiding member.

16. The shade assembly according to claim 13, wherein, the tube has an aperture extending longitudinally thereon.

17. The shade assembly according to claim 16, wherein, the tube guiding member has a second grooved portion for attaching to an inner wall of the tube, and a protrusion for locating in the aperture.

18. The shade assembly according to claim 17, further comprising a housing with a housing passage for accommodating the tube.

19. The shade assembly according to claim 18, wherein, the first cap has at least one connecting hole, and wherein at least one housing hole corresponding to the connecting hole is provided on the housing, and wherein at least one connecting member for fixing the first cap to the housing is provided.

20. The shade assembly according to claim 18, wherein, the housing has a housing aperture allowing the shade to pass therethrough.
